(19) United States
(12) Patent Application Publication
(10) Pub. No.: US 2025/0103380 A1
(43) Pub. Date: Mar. 27, 2025

(54) VIRTUALIZATION OF DEVICE INTERFACES

(71) Applicant: Intel Corporation, Santa Clara, CA (US)

(72) Inventors: Kasper WSZOLEK, Gdansk (PL); Janusz JURSKI, Beaverton, OR (US); Mariusz ORIOL, Gdynia (PL); Matthew James ADILETTA, Bolton, MA (US)

(21) Appl. No.: 18/973,872

(22) Filed: Dec. 9, 2024

(51) Int. Cl. G06F 9/455; G06F 13/38; G06F 13/42

(52) U.S. Cl. CPC G06F 9/45558; G06F 13/382; G06F 13/4221; G06F 13/4282; G06F 2009/45579; G06F 2213/0016; G06F 2213/0026; G06F 2213/0042

(57) ABSTRACT

Examples described herein relate to at least one processor that is to communicate with a management controller to communicate with multiple interfaces. In some examples, wherein at least two of the multiple interfaces are to provide boot firmware code to the at least one processor and a connection interface.

### BACKGROUND

Processors utilize input output (IO) pins to transmit and receive communications with other devices. As the number of interfaces increases, increasing a number of pins to access the interfaces and devices may not be possible. For example, a number of pins can be limited by physical space or constrained by cost. Accordingly, some processors have access to a limited number of pins, and a limited number of interfaces and devices.

### BRIEF DESCRIPTION OF THE DRAWINGS

FIG. 1 depicts an example system.

FIG. 2 depicts an example system.

FIG. 3 depicts an example of operations.

FIG. 4A depicts an example process.

FIG. 4B depicts an example process.

FIG. 5 depicts an example system.

### DETAILED DESCRIPTION

A processor socket can include a ball grid array (BGA), Pin Grid Array (PGA), Land Grid Array (LGA), or other interface that can couple a processor to a circuit board (e.g., printed circuit board (PCB)), without soldering the processor to the circuit board. For a processor socket connected to a server platform node, there can be a limited number of pins for boot and management interfaces. For example, boot and manageability interfaces with corresponding number of IO pins per processor socket is as follows: pins per socket for Enhanced Serial Peripheral Interface (eSPI), pins per socket for Quad Serial Peripheral Interface (QSPI), pins per socket for universal asynchronous receiver/transmitter (UART), pins per socket for SMBus, pins per socket for Trusted Platform Module (TPM) SPI, pins per socket for Peripheral Component Interconnect express (PCIe), and pins per socket for Improved Inter-Integrated Circuit (I3C).

Processor sockets in multi-socket system (socket level partitioning) or processors resources within a given socket (sub-socket level partitioning), or a combination thereof, can be partitioned so that processor resources are isolated among different partitions. For example, an example of number of IO pin interfaces with sub-socket level partitioning support can be: 34 pins per socket for 1 partition (non-partitioned), 68 pins per socket for 2 partitions, 136 pins per socket for 4 partitions, and 272 pins per socket for 8 partitions.

A Baseboard Management Controller (BMC) can be utilized to boot and manage and monitor operations of a server platform node with a processor socket. However, where the number of IO pins to the BMC are limited, scaling up the number of server platform nodes that are managed by the BMC can be limited by the number of IO pins supported by a single BMC.

At least to provide for communication between a management controller and multiple processors or processor socket partitions with a limited number of IO pins, various examples provide for processors that utilize circuitry as an intermediary for communications by a processor-executed process with various interfaces and/or devices. For example, the processor-executed process can request access to a particular interface or device by writing to a register associated with the interface or device, and the circuitry can forward the communication to the management controller. The management controller can receive the communication and provide the communication to the requested interface or device, such as access to boot firmware, access to a clock source, access to a trusted computing environment, or access to other devices, firmware, or software. Various example can reduce IO pin count for interfaces to multi-node and partitionable systems by providing a processor with access to a single consolidated interface.

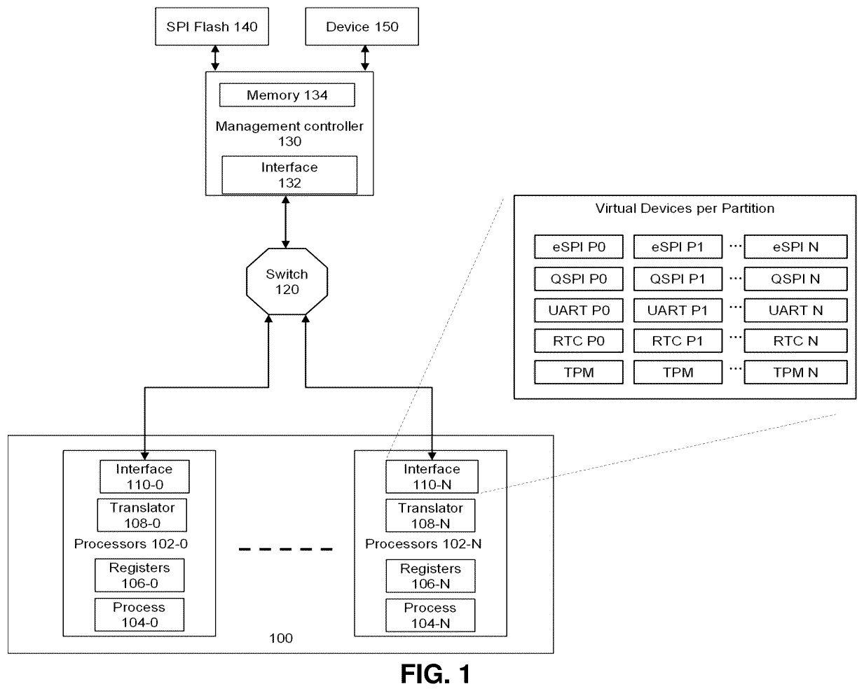

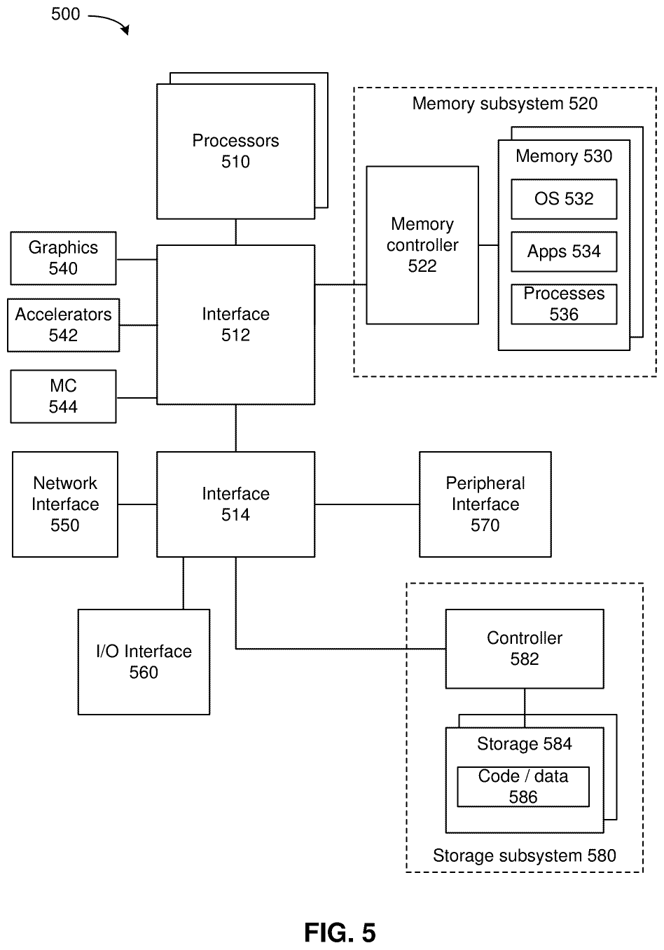

FIG. 1 depicts an example system. Socket 100 can include associated processors 102-0 to 102-N, where N is an integer, as well as silicon firmware and other software or circuitry described at least with respect to FIG. 5. In some examples, socket 100 can include a cover that is made of plastic and can include metal contacts for pins or lands of processors 102. Processors with a pin grid array (PGA) or land grid array (LGA) package can be inserted into a socket. In some examples, socket 100 can include a physical package that includes one or more discrete dies or tiles connected by mesh or other connectivity as well as an interface (not shown) and heat dispersion (not shown). A die can include semiconductor devices that include one or more processing devices or other circuitry. A tile can include semiconductor devices that include one or more processing devices or other circuitry. For example, a physical package can include one or more dies, plastic or ceramic housing for the dies, and conductive contacts conductively coupled to a circuit board.

Processors 102-0 and 102-N can include one or more of: a central processing unit (CPU), a processor core, graphics processing unit (GPU), neural processing unit (NPU), general purpose GPU (GPGPU), field programmable gate array (FPGA), application specific integrated circuit (ASIC), tensor processing unit (TPU), matrix math unit (MMU), or other circuitry. A processor core can include an execution core or computational engine that is capable of executing instructions. A core can access to its own cache and read only memory (ROM), or multiple cores can share a cache or ROM. Cores can be homogeneous (e.g., same processing capabilities) and/or heterogeneous devices (e.g., different processing capabilities). Frequency or power use of a core can be adjustable. A core can be sold or designed by Intel®, ARM®, Advanced Micro Devices, Inc. (AMD)®, Qualcomm®, IBM®, Nvidia®, Broadcom®, Texas Instruments®, or compatible with reduced instruction set computer (RISC) instruction set architecture (ISA) (e.g., RISC-V), among others.

Processors 102-0 to 102-N can be heterogeneous or homogeneous processor types where processors in different sockets are a same type (e.g., CPU, GPU, NPU, etc.) or different type. (e.g., a first socket includes a CPU and a GPU and a second socket includes a GPU and an NPU).

Any type of inter-processor communication techniques can be used, such as but not limited to messaging, inter-processor interrupts (IPI), inter-processor communications, and so forth. Cores can be connected in any type of manner, such as but not limited to, bus, ring, or mesh. Cores may be coupled via an interconnect to a system agent (uncore).

A system agent can include a shared cache which may include any type of cache (e.g., level 1, level 2, or last level cache (LLC)). A system agent can include or more of: a memory controller, a shared cache, a cache coherency manager, arithmetic logic units, floating point units, core or processor interconnects, or bus or link controllers. A system agent or uncore can provide one or more of: direct memory access (DMA) engine connection, non-cached coherent master connection, data cache coherency between cores and arbitrate cache requests, or Advanced Microcontroller Bus Architecture (AMBA) capabilities. System agent or uncore can manage priorities and clock speeds for receive and transmit fabrics and memory controllers.

One or more of processors can execute processes 104-0 to 104-N. Processes 104-0 to 104-N can include one or more of: application, process, thread, a virtual machine (VM), micro VM, container, microservice, or other virtualized execution environment. Processes 104-0 to 104-N can perform packet processing based on one or more of Data Plane Development Kit (DPDK), Storage Performance Development Kit (SPDK), OpenDataPlane, Network Function Virtualization (NFV), software-defined networking (SDN), Evolved Packet Core (EPC), or 5G network slicing. Some example implementations of NFV are described in European Telecommunications Standards Institute (ETSI) specifications or Open Source NFV Management and Orchestration (MANO) from ETSI's Open Source Mano (OSM) group. A virtual network function (VNF) can include a service chain or sequence of virtualized tasks executed on generic configurable hardware such as firewalls, domain name system (DNS), caching or network address translation (NAT) and can run in virtual execution environments. VNFs can be linked together as a service chain. In some examples, EPC is a 3GPP-specified core architecture at least for Long Term Evolution (LTE) access. 5G network slicing can provide for multiplexing of virtualized and independent logical networks on the same physical network infrastructure. Processes 154 can perform operations associated with artificial intelligence (AI) or machine learning (ML) operations such as collective operations or operations of a kernel.

One or more of processes 104-0 to 104-N can access interfaces or devices by writing to associated registers 106-0 to 106-N. For example, processes 104-0 to 104-N can access various interfaces or devices (e.g., eSPI, QSPI, UART, Host SMBus, I2C, general purpose IO (GPIO) pins, real time clock (RTC), Trusted Platform Module (TPM), or others) as virtual devices. A TPM can use cryptography to securely store critical information utilized during authentication of a platform (e.g., socket 100). For example, a TPM can operate in a manner consistent with Trusted Computing Group (TCG) “Trusted Platform Module Library Specification, Family 2.0, Level 00, Revision 01.83 (March 2024), as well as earlier and later versions or variations thereof.

One or more of processes 104-0 to 104-N can access interfaces or devices by writing to specific memory addresses in accordance with memory-mapped interface (MMIO) that virtualizes accesses to management interfaces for platform boot and partitioning use cases such as: PCIe, USB, eSPI, QSPI, UART, host SMBus, GPIOs, I2C RTC, TPM, or others.

Various examples can consolidate and virtualize interfaces such as SPI Flash, SPI TPM, eSPI, PECI, UART, SMBus, JTAG, GPIO wires, or others into a single callable interface to access boot firmware, firmware updates, and manage processors or accelerators. One or more of processors 102-0 to 102-N can access interfaces or devices by access to management controller 130, including management interfaces for platform management, platform boot, and telemetry interfaces. Accesses to management controller 130 can virtualize interfaces to eSPI, QSPI, RTC SMBus, UART, I3C, or others for a management and debug sideband interface, medium for boot firmware and firmware patch loading, PCIe interface access, or others.

In some examples, processors 102-0 to 102-N can execute respective translators 108-0 to 108-N (e.g., microcode or firmware) to translate requests to access an interface or device as a virtual device. Processes 104-0 to 104-N can issue or request, at least: interrupts, time stamps, read requests, write requests, status, or others. Interface 110-0 to 110-N can transmit the request using Management Component Transport Protocol (MCTP) protocol to management controller 130. However, other communications standards can be used such as Integrity and Data Encryption (IDE), Component Measurement and Authentication (CMA), Data Object Exchange (DOE), Distributed Management Task Force (DMTF) Security Protocol and Data Model (SPDM), or other encryption technologies. Communications received from management controller 130 can be written to a register associated with a protocol or device and read by a receiver process (e.g., 104-0 to 104-N). By utilizing a single virtualized interface, security and confidentiality of communications can be protected more readily than using multiple interfaces. Platform security can be improved by replacing multiple unprotected (e.g., plain-text) interfaces with a single protected interface with end-to-end encryption per partition and can provide secure isolation between partitions.

In some examples, switch 120 (e.g., switch, hub, management controller, or other device that provides fanout with isolation between partitions) can receive communications between one or more of processors 102-0 to 102-N and management controller 130. Switch 120 can scale out a number of processors able to access various interfaces and devices by providing a single point of contact. A single management controller 130 can act as a root or host for the boot and management interfaces of processors 102-0 to 102-N. In some examples, management controller 130 can include a PCIe root port (RP) and processors 102-0 to 102-N can be accessed as PCIe endpoints so that a single management controller can fanout to multiple processors. For example, management controller 130 can be a USB host that can address up to 127 processors or a PCIe Root Port that can access 16 millions of endpoint processors. Other numbers of processors or management controllers can be used. In some examples, I3C technology can be used by a management controller (e.g., I3C controller device) to access up to 127 processors (e.g., I3C target devices).

Management controller 130 can perform management and monitoring capabilities for system administrators to manage and monitor operation at least of a host and devices connected thereto (e.g., processors 102-0 to 102-N, a network interface device, and storage device), using channels, including channels that can communicate data (e.g., in-band channels) and out-of-band channels. Out-of-band channels can include packet flows or transmission media that communicate metadata and telemetry and may not communicate data. In some examples, management controller 130 can be implemented as one or more of: Board Management Controller (BMC), Intel® Management or Manageability Engine (ME), or other devices.

In some examples, management controller 130 can execute firmware or software that receives requests from one or more of processors 102-0 to 102-N to software executed by management controller 130 or circuitry communicatively coupled to management controller 130. For example, management controller 130 can decode received messages or packets from processors 102-0 to 102-N via switch 120. Management controller 130 can provide interfaces for communications to devices via eSPI, QPSI, UART, or accesses to RTC, TPM, SPI flash 140, or device 150. Management controller 130 can provide multiple isolated execution domains of clock for RTC and TPM. Device 150 can include one or more of: a network interface device, accelerator, field programmable gate array (FPGA), application specific integrated circuit (ASIC), a processor, or other circuitry.

Management controller 130 can cache and serve flash boot firmware images from SPI flash 140 to one or more of processors 102-0 to 102-N. In some examples, management controller 130 can cache and serve flash boot firmware images from other interfaces, such as eSPI, Ethernet, or others. In some examples, boot firmware code or firmware can include one or more of: Basic Input/Output System (BIOS), Universal Extensible Firmware Interface (UEFI), a boot loader, microcode, or microcode patching. The BIOS firmware can be pre-installed on a personal computer's system board or accessible through an SPI interface from a boot storage (e.g., flash memory). In some examples, firmware can include Intel® Server Platform Services (SPS) Firmware. In some examples, a Universal Extensible Firmware Interface (UEFI) can be used instead or in addition to a BIOS for booting or restarting cores or processors. UEFI is a specification that defines a software interface between an operating system and platform firmware. UEFI can read from entries from disk partitions by not just booting from a disk or storage but booting from a specific boot loader in a specific location on a specific disk or storage. UEFI can support remote diagnostics and repair of computers, even with no operating system installed. A boot loader can be written for UEFI and can be instructions that a boot code firmware can execute and the boot loader is to boot the operating system(s). A UEFI bootloader can be a bootloader capable of reading from a UEFI type firmware.

A UEFI capsule is a manner of encapsulating a binary image for firmware code updates. But in some examples, the UEFI capsule is used to update a runtime component of the firmware code. The UEFI capsule can include updatable binary images with relocatable Portable Executable (PE) file format for executable or dynamic linked library (dll) files based on COFF (Common Object File Format). For example, the UEFI capsule can include executable (*.exe) files. This UEFI capsule can be deployed to a target platform as an SMM image via existing OS specific techniques (e.g., Windows Update for Azure, or LVFS for Linux).

While examples are described with respect to management controller, instead of, or in addition to use if management controller 130, one or more of the following can receive and respond to requests from a processor: a network interface device, accelerator, field programmable gate array (FPGA), application specific integrated circuit (ASIC), a processor, or other circuitry. BMC can be another device such as an IPU (acting as management controller), accelerator (acting as management controller), or other device (acting as management controller)

In some examples, communications between processors 102-0 to 102-N, switch 120, management controller 130, and/or device 150 can operate in a manner consistent at least with: SPI, eSPI, SMBUS, I3C, Infinity Fabric from Advanced Micro Devices, Inc. (AMD), universal serial bus (USB) (e.g., USB 1.1, 2.0, 3.0, 4.0, and variations thereof and other versions of USB), AMD HyperTransport, NVIDIA® NVLink, Intel® QuickPath Interconnect (QPI), Advanced Microcontroller Bus Architecture (AMBA), Coherent Hub Interface (CHI) Chip to Chip (C2C), TileLink, RISC-V processor interconnect, Intel® Ultra Path Interconnect (UPI), Intel® On-Chip System Fabric (IOSF), Omnipath, Compute Express Link (CXL) (see, for example, Compute Express Link Specification revision 2.0, version 0.7 (2019), as well as earlier versions, later versions, and variations thereof), Peripheral Component Interconnect express (PCIe) (see, for example, Peripheral Component Interconnect (PCI) Express Base Specification 1.0 (2002), as well as earlier versions, later versions, and variations thereof), or other public or proprietary standards.

A computing system (e.g., server) can include multiple processor sockets that communicate with each other to increase available processor and cache and memory resources. For example, Intel® Xeon processor sockets can be connected in various configurations, such as 1 socket (1S), 2 socket (2S), 4 socket (4S), 8 socket (8S), or above 8S configurations. Cloud Service Providers (CSPs) and High Performance Computing (HPC) applications can utilize flexible socket partitioning to create isolated zones to dynamically operate a server in an 8S system setup with two isolated 4S zones (2×4S) or 4×2S, or other configurations, based on total cost of ownership (TCO), workload placement, or data center orchestrator planning.

Socket level partitioning, sub-socket level partitioning, or a combination thereof, allows a platform with multiple processor sockets to boot in a single system that executes a single operating system (OS) or multiple independent single socket systems that execute multiple operating systems. For example, in a non-partitioned mode, a 2S platform can operate as a single node, and resources connected to the two processor sockets are part of the single node. For instance, processor sockets (e.g., 102-0 to 102-N) in the non-partitioned mode can execute a single boot firmware (e.g., boot firmware stored in flash 140) and perform a handoff platform control to a single OS. Processors (e.g., 102-0 to 102-N) in the non-partitioned mode, including software (e.g., OS or processes) can share resources such as connected memory, cores in different sockets, cache, connected input/output (I/O), device interface-connected devices (e.g., Peripheral Component Interconnect express (PCIe), Compute Express Link (CXL)) and other circuitry, firmware, or software. Processors in the non-partitioned mode can access memory in a coherent manner so that memory is shared among the processors.

For example, in a partitioned mode, a 2S platform can operate as two separate sockets and can operate in independent power states (e.g., S0, S5, and so on), perform separate error handling, and not share one or more of: connected memory, cores in different sockets, cache, isolated input/output (I/O) communication interfaces, or device interface-connected devices. Partitions can operate as separate coherent domains. Moreover, in partitioned mode, different socket partitions (e.g., 102-0 to 102-N) can independently power cycle, utilize different and independent clock signals, different partitions can utilize isolated in-band and out-of-band channels, different partitions can independently communicate with one or more management controllers, different partitions can utilize one or more debug ports, different partitions can independently utilize one or more root of trust devices that authenticate or validate different boot firmware, or others. Multiple processors (e.g., 102-0 to 102-N) can execute separate boot firmware code and handoff platform control to OSs executed by different processors. In a partitioned mode, peripheral or telemetry data may not be shared among different partitioned processor sockets, storage dependency may not be shared among different partitioned processor sockets, and so forth. In a partitioned mode, cross socket isolation can occur whereby sockets have independent power states. A catastrophic Reliability, Availability and Serviceability (RAS) event in a partition may not impact the run-time stability of another partitions.

For partitioned mode, bifurcation of resources (e.g., cache, memory, memory controllers, registers, processors, interfaces, physical layer interfaces, or others) among partitions may be equal or unequal and set based on service level agreement (SLA), service level objectives (SLO), application request, data center administrator configuration, or others.

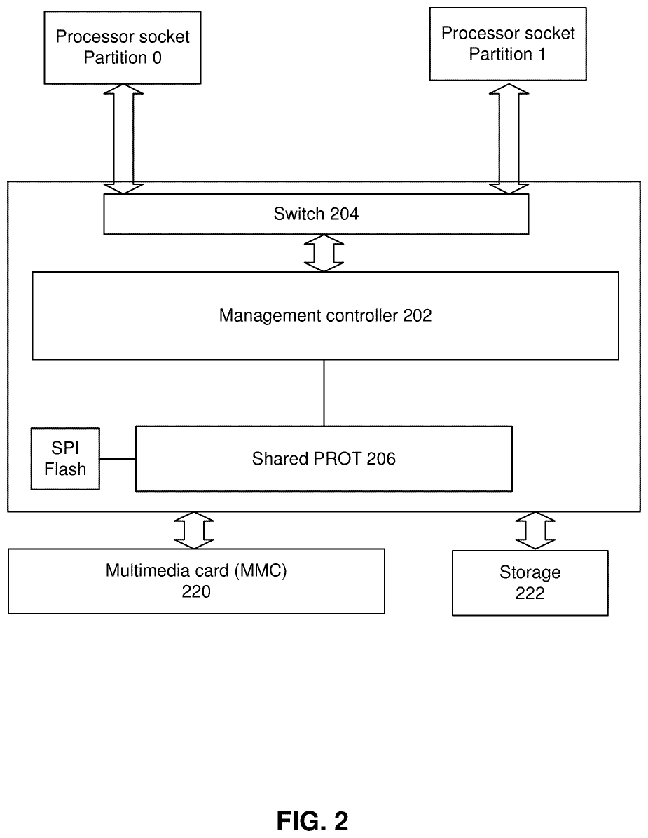

FIG. 2 depicts an example system. In this example, a processor socket can be partitioned into two partitions. As described herein with respect to FIG. 1, management controller 202 can provide a single interface for processor socket partitions 0 and 1 to various interfaces (e.g., eSPI, QSPI, UART), a root of trust (e.g., platform root of trust (PROT) 206 or TPM), RTC, multimedia card 220, and boot firmware from storage 222. While the example of FIG. 2 is described with respect to multiple socket partitions, the example can apply to multiple different processor sockets. Instead of duplication of interfaces for sub-socket-level partitions, various examples can support boot interfaces and manageability interfaces via management controller 202.

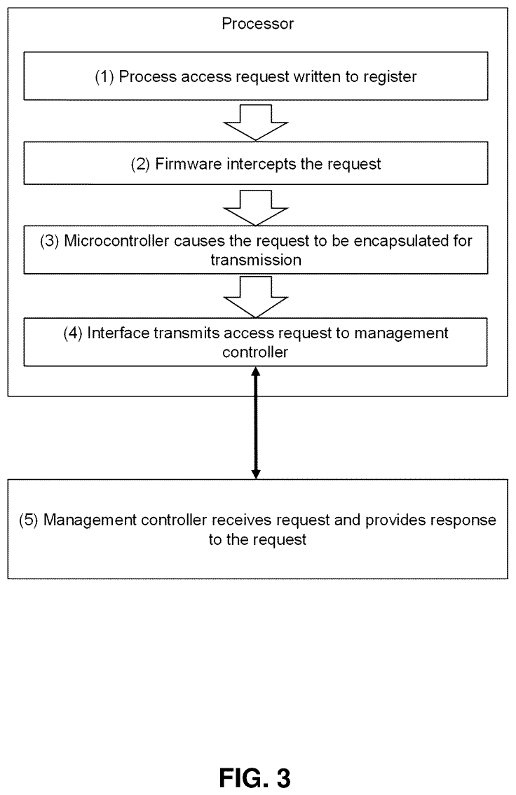

FIG. 3 depicts an example of operations. An example of operations for processors to communicate with a single interface (e.g., management controller or other devices) to access multiple interfaces is as follows. At (1), processor-executed software writes a communication to a register, port, or MMIO address, or device or reads from a register, port, MMIO address, or device. An operating system, system administrator, or orchestrator can allocate one or more register, port, or MMIO address to eSPI, QPSI, UART, or other interfaces, or devices such as RTC or TPM. At (2), processor-executed firmware (e.g., BIOS or UEFI) can intercept a read or write access to register, port, MMIO address, or device and cause, at (3), microcode or embedded microcontroller to encapsulate the command from the software as a MCTP message and, at (4), cause transmission of the message to a management controller or other device. At (5), the management controller can decode the MCTP message. The management controller can provide the communication to an interface (e.g., eSPI, QPSI, UART) or device (e.g., RTC, TPM, boot firmware), or other devices, firmware, or software.

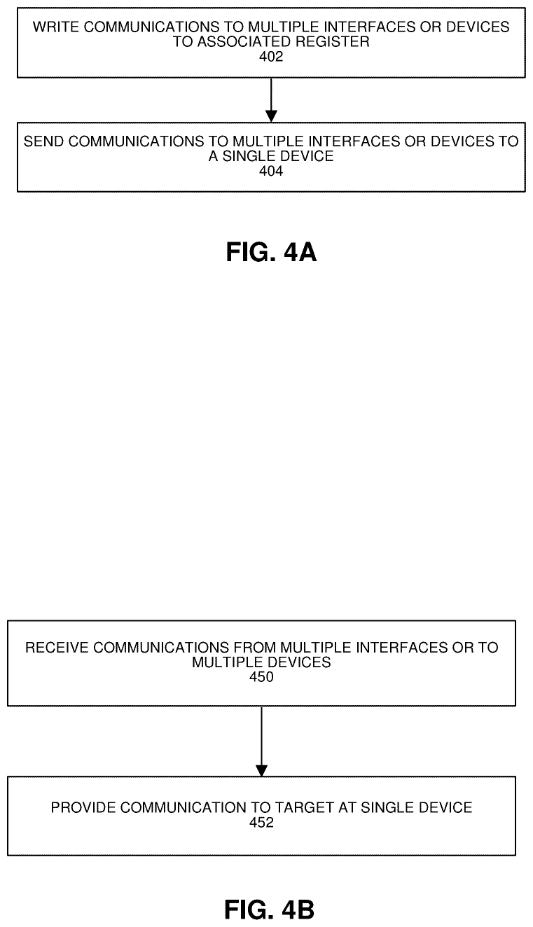

FIG. 4A depicts an example process. The process can be performed by a processor or other circuitry, in some examples. At 402, a processor-executed process can write a communication to a register. For example, the communication can comply with a protocol or access a particular device or software. For example, a protocol can include eSPI, QSPI, UART, SMBus, I2C, or others. For example, a device can include general purpose IO (GPIO) pins, real time clock (RTC), Trusted Platform Module (TPM), or others.

At 404, the processor can send the communication to a management controller or other device so that communications to multiple interfaces or devices are sent to a single device. For example, firmware can read a register associated with a destination and can convey the communication in one or more packets to the management controller as a single device.

FIG. 4B depicts an example process. The process can be performed by a management controller, in some examples. At 450, based on receipt of a communication from a processor, a target can be determined. For example, a target can correspond to a particular endpoint to an interface consistent with a particular protocol, a device, or others. For example, a protocol can include eSPI, QSPI, UART, SMBus, I2C, or others. For example, a device can include GPIO pins, RTC, TPM, or others. At 452, the management controller can provide the communication to the target. For example, the management controller can terminate the communication at a particular interface or provide the communication to a particular device.

FIG. 5 depicts a system. In some examples, one or more circuitry of system 500 (e.g., processors 510, graphics 540, accelerators 542, or others) can be configured to access management controller 544 (e.g., via interface 512 or 514) or other circuitry to access an interface, device, software, and/or firmware, as described herein. System 500 includes processor 510, which provides processing, operation management, and execution of instructions for system 500. Processor 510 can include any type of microprocessor, central processing unit (CPU), graphics processing unit (GPU), XPU, processing core, or other processing hardware to provide processing for system 500, or a combination of processors. An XPU can include one or more of: a CPU, a graphics processing unit (GPU), general purpose GPU (GPGPU), and/or other processing units (e.g., accelerators or programmable or fixed function FPGAs). Processor 510 controls the overall operation of system 500, and can be or include, one or more programmable general-purpose or special-purpose microprocessors, digital signal processors (DSPs), programmable controllers, application specific integrated circuits (ASICs), programmable logic devices (PLDs), or the like, or a combination of such devices. Processor 510 can include multiple processors and multiple processors can be embodied as processor sockets.

In one example, system 500 includes interface 512 coupled to processor 510, which can represent a higher speed interface or a high throughput interface for system components, such as memory subsystem 520 or graphics interface components 540, or accelerators 542. Interface 512 represents an interface circuit, which can be a standalone component or integrated onto a processor die. Where present, graphics interface 540 interfaces to graphics components for providing a visual display to a user of system 500. In one example, graphics interface 540 generates a display based on data stored in memory 530 or based on operations executed by processor 510 or both. In one example, graphics interface 540 generates a display based on data stored in memory 530 or based on operations executed by processor 510 or both.

Accelerators 542 can be a programmable or fixed function offload engine that can be accessed or used by a processor 510. For example, an accelerator among accelerators 542 can provide data compression (DC) capability, cryptography services such as public key encryption (PKE), cipher, hash/authentication capabilities, decryption, or other capabilities or services. In some cases, accelerators 542 can be integrated into a CPU socket (e.g., a connector to a motherboard or circuit board that includes a CPU and provides an electrical interface with the CPU). For example, accelerators 542 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 542 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models to perform learning and/or inference operations.

Management controller 544 can provide multiple processors 510 with access to an interface, device, software, and/or firmware, as described herein. Management controller 544 can perform management and monitoring capabilities for system administrators or orchestrators to manage and monitor operation of system 500.

Memory subsystem 520 represents the main memory of system 500 and provides storage for code to be executed by processor 510, or data values to be used in executing a routine. Memory subsystem 520 can include one or more memory devices 530 such as read-only memory (ROM), flash memory, one or more varieties of random access memory (RAM) such as DRAM, or other memory devices, or a combination of such devices. Memory 530 stores and hosts, among other things, operating system (OS) 532 to provide a software platform for execution of instructions in system 500. Additionally, applications 534 can execute on the software platform of OS 532 from memory 530. Applications 534 represent programs that have their own operational logic to perform execution of one or more functions. Processes 536 represent agents or routines that provide auxiliary functions to OS 532 or one or more applications 534 or a combination. OS 532, applications 534, and processes 536 provide software logic to provide functions for system 500. In one example, memory subsystem 520 includes memory controller 522, which is a memory controller to generate and issue commands to memory 530. It will be understood that memory controller 522 could be a physical part of processor 510 or a physical part of interface 512. For example, memory controller 522 can be an integrated memory controller, integrated onto a circuit with processor 510.

Applications 534 and/or processes 536 can refer instead or additionally to a virtual machine (VM), container (e.g., Docker container), microservice, processor, or other software. Various examples described herein can perform an application composed of microservices, where a microservice runs in its own process and communicates using protocols (e.g., application program interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), or lightweight container or virtual machine deployment, and decentralized continuous microservice delivery.

In some examples, OS 532 can be Linux®, FreeBSD, Windows® Server or personal computer, FreeBSD®, Android®, MacOS®, iOS®, VMware vSphere, openSUSE, RHEL, CentOS, Debian, Ubuntu, or any other operating system. The OS and driver can execute on a processor sold or designed by Intel®, ARM®, AMD®, Qualcomm®, IBM®, Nvidia®, Broadcom®, Texas Instruments®, among others.

While not specifically illustrated, it will be understood that system 500 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 500 includes interface 514, which can be coupled to interface 512. In one example, interface 514 represents an interface circuit, which can include standalone components and integrated circuitry. In one example, multiple user interface components or peripheral components, or both, couple to interface 514. Network interface 550 provides system 500 the ability to communicate with remote devices (e.g., servers, workstations, or other computing devices) over one or more networks. Network interface 550 can include an Ethernet adapter, wireless interconnection components, cellular network interconnection components, USB (universal serial bus), or other wired or wireless standards-based or proprietary interfaces. Network interface 550 can transmit data to a device that is in the same data center or rack or a remote device, which can include sending data stored in memory. Network interface 550 can receive data from a remote device, which can include storing received data into memory. In some examples, packet processing device or network interface device 550 can refer to one or more of: a network interface controller (NIC), a remote direct memory access (RDMA)-enabled NIC, SmartNIC, router, switch, forwarding element, infrastructure processing unit (IPU), or data processing unit (DPU). An example IPU or DPU is described herein.

In one example, system 500 includes one or more input/output (I/O) interface(s) 560. I/O interface 560 can include one or more interface components through which a user interacts with system 500. Peripheral interface 570 can include any hardware interface not specifically mentioned above. Peripherals refer generally to devices that connect dependently to system 500.

In one example, system 500 includes storage subsystem 580 to store data in a nonvolatile manner. In one example, in certain system implementations, at least certain components of storage 580 can overlap with components of memory subsystem 520. Storage subsystem 580 includes storage device(s) 584, which can be or include any conventional medium for storing large amounts of data in a nonvolatile manner, such as one or more magnetic, solid state, or optical based disks, or a combination. Storage 584 holds code or instructions and data 586 in a persistent state (e.g., the value is retained despite interruption of power to system 500). Storage 584 can be generically considered to be a “memory,” although memory 530 is typically the executing or operating memory to provide instructions to processor 510. Whereas storage 584 is nonvolatile, memory 530 can include volatile memory (e.g., the value or state of the data is indeterminate if power is interrupted to system 500). In one example, storage subsystem 580 includes controller 582 to interface with storage 584. In one example controller 582 is a physical part of interface 514 or processor 510 or can include circuits or logic in both processor 510 and interface 514.

A volatile memory can include memory whose state (and therefore the data stored in it) is indeterminate if power is interrupted to the device. A non-volatile memory (NVM) device can include a memory whose state is determinate even if power is interrupted to the device.

In some examples, system 500 can be implemented using interconnected compute platforms of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe (e.g., a non-volatile memory express (NVMe) device can operate in a manner consistent with the Non-Volatile Memory Express (NVMe) Specification, revision 1.3c, published on May 24, 2018 (“NVMe specification”) or derivatives or variations thereof).

Communications between devices can take place using a network that provides die-to-die communications; chip-to-chip communications; circuit board-to-circuit board communications; and/or package-to-package communications. Die-to-die communications can utilize Embedded Multi-Die Interconnect Bridge (EMIB) or an interposer. Components of examples described herein can be enclosed in one or more semiconductor packages. A semiconductor package can include metal, plastic, glass, and/or ceramic casing that encompass and provide communications within or among one or more semiconductor devices or integrated circuits. Various examples can be implemented in a die, in a package, or between multiple packages, in a server, or among multiple servers. A system in package (SiP) can include a package that encloses one or more of: an SoC, one or more tiles, or other circuitry.

In an example, system 500 can be implemented using interconnected compute platforms of processors, memories, storages, network interfaces, and other components. High speed interconnects can be used such as PCIe, Ethernet, or optical interconnects (or a combination thereof).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. For example, descriptions using the terms “connected” and/or “coupled” may indicate that two or more elements are in direct physical or electrical contact. The term “coupled,” however, may also mean that two or more elements are not in direct contact, but yet still co-operate or interact.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be present. Additionally, conjunctive language such as the phrase “at least one of X, Y, and Z,” unless specifically stated otherwise, should also be understood to mean X, Y, Z, or any combination thereof, including “X, Y, and/or Z.”’

Illustrative examples of the devices, systems, and methods disclosed herein are provided below. An embodiment of the devices, systems, and methods may include any one or more, and any combination of, the examples described below.

Example 1 includes one or more examples and includes an apparatus that includes: an interface and at least one processor, coupled to the interface, wherein the at least one processor is to: communicate with a management controller to communicate with multiple interfaces, wherein at least two of the multiple interfaces are to provide boot firmware code to the at least one processor and a connection interface, wherein the connection interface is consistent with one or more of: Enhanced Serial Peripheral Interface (eSPI), universal asynchronous receiver/transmitter (UART), SMBus, Peripheral Component Interconnect express (PCIe), or Improved Inter-Integrated Circuit (I3C), and wherein the management controller is to manage and monitor operations.

Example 2 includes one or more examples, wherein the at least one processor comprises circuitry to provide a request to access an interface of the multiple interfaces to the management controller and wherein the multiple interfaces provide interfaces to multiple devices.

Example 3 includes one or more examples, wherein: the at least one processor is to access the multiple interfaces and devices by access to memory-mapped input output (MMIO) addresses.

Example 4 includes one or more examples, wherein the management controller is to access the at least one processor as a Peripheral Component Interconnect Express (PCIe) endpoint, Universal Serial Bus (USB) endpoint, or I3C endpoint.

Example 5 includes one or more examples, wherein the management controller is to manage and monitor operations of multiple processor sockets.

Example 6 includes one or more examples, wherein multiple processor socket partitions receive management signals from the management controller and provide monitoring signals to the management controller.

Example 7 includes one or more examples, wherein the at least one processor is to provide communications to the management controller to route to a target interface or device.

Example 8 includes one or more examples, and includes: a switch to route communications between the at least one processor and at least one processor socket to the management controller.

Example 9 includes one or more examples, and includes at least one non-transitory computer-readable medium comprising instructions stored thereon, that if executed by one or more processors, cause the one or more processors to: configure a baseboard management controller to: manage and monitor operations of multiple processors and provide at least one of the multiple processors with a single interface to multiple interfaces and devices.

Example 10 includes one or more examples, wherein at least one of the multiple processors comprises circuitry to provide a request to access an interface of the multiple interfaces to the baseboard management controller.

Example 11 includes one or more examples, wherein multiple processors access the multiple interfaces and devices by accessing memory-mapped input output (MMIO) addresses.

Example 12 includes one or more examples, wherein the baseboard management controller is to access the multiple processors as Peripheral Component Interconnect Express (PCIe) endpoint, Universal Serial Bus (USB) endpoint, or I3C endpoint.

Example 13 includes one or more examples, wherein at least one of the multiple processors comprises a processor socket.

Example 14 includes one or more examples, wherein at least one of the multiple processors includes a processor socket partition.

Example 15 includes one or more examples, wherein the baseboard management controller is to route communications from the multiple processors to a target interface or device.

Example 16 includes one or more examples, and includes a process of making a processor that includes: connecting a processor to an interface, wherein the interface provides the processor with access to multiple interfaces and devices by communication with a baseboard management controller, wherein at least one of the multiple interfaces is to provide boot firmware code to the processor.

Example 17 includes one or more examples, wherein: the processor comprises circuitry to translate a communication written to a register by the processor and transmit the translated communication to an associated interface of the multiple interfaces or devices.

Example 18 includes one or more examples, wherein: the processor accesses the multiple interfaces or devices by accessing memory-mapped input output (MMIO) addresses.

Example 19 includes one or more examples, wherein: the baseboard management controller accesses the processor as a Peripheral Component Interconnect Express (PCIe) endpoint, Universal Serial Bus (USB) endpoint, or I3C endpoint.

Example 20 includes one or more examples, wherein: the processor includes a processor socket, socket-level partition, or sub-socket level partition.

1. An apparatus comprising:
an interface and
at least one processor, coupled to the interface, wherein the at least one processor is to:
communicate with a management controller to communicate with multiple interfaces, wherein at least two of the multiple interfaces are to provide boot firmware code to the at least one processor and a connection interface, wherein the connection interface is consistent with one or more of: Enhanced Serial Peripheral Interface (eSPI), universal asynchronous receiver/transmitter (UART), SMBus, Peripheral Component Interconnect express (PCIe), or Improved Inter-Integrated Circuit (I3C), and wherein the management controller is to manage and monitor operations.

2. The apparatus of claim 1, wherein the at least one processor comprises circuitry to provide a request to access an interface of the multiple interfaces to the management controller and wherein the multiple interfaces provide interfaces to multiple devices.

3. The apparatus of claim 1, wherein:
the at least one processor is to access the multiple interfaces and devices by access to memory-mapped input output (MMIO) addresses.

4. The apparatus of claim 1, wherein the management controller is to access the at least one processor as a Peripheral Component Interconnect Express (PCIe) endpoint, Universal Serial Bus (USB) endpoint, or Improved Inter-Integrated Circuit (I3C) endpoint.

5. The apparatus of claim 1, wherein the management controller is to manage and monitor operations of multiple processor sockets.

6. The apparatus of claim 1, wherein multiple processor socket partitions receive management signals from the management controller and provide monitoring signals to the management controller.

7. The apparatus of claim 1, wherein the at least one processor is to provide communications to the management controller to route to a target interface or device.

8. The apparatus of claim 1, comprising: a switch to route communications between the at least one processor and at least one processor socket to the management controller.

9. At least one non-transitory computer-readable medium comprising instructions stored thereon, that if executed by one or more processors, cause the one or more processors to:
configure a baseboard management controller to:
manage and monitor operations of multiple processors and
provide at least one of the multiple processors with a single interface to multiple interfaces and devices.

10. The at least one non-transitory computer-readable medium of claim 9, wherein at least one of the multiple processors comprises circuitry to provide a request to access an interface of the multiple interfaces to the baseboard management controller.

11. The at least one non-transitory computer-readable medium of claim 9, wherein multiple processors access the multiple interfaces and devices by accessing memory-mapped input output (MMIO) addresses.

12. The at least one non-transitory computer-readable medium of claim 9, wherein the baseboard management controller is to access the multiple processors as Peripheral Component Interconnect Express (PCIe) endpoint, Universal Serial Bus (USB) endpoint, or Improved Inter-Integrated Circuit (I3C) endpoint.

13. The at least one non-transitory computer-readable medium of claim 9, wherein at least one of the multiple processors comprises a processor socket.

14. The at least one non-transitory computer-readable medium of claim 9, wherein at least one of the multiple processors comprises a processor socket partition.

15. The at least one non-transitory computer-readable medium of claim 9, wherein the baseboard management controller is to route communications from the multiple processors to a target interface or device.

16. A process of making a processor comprising:
connecting a processor to an interface, wherein the interface provides the processor with access to multiple interfaces and devices by communication with a baseboard management controller, wherein at least one of the multiple interfaces is to provide boot firmware code to the processor.

17. The process of claim 16, wherein:
the processor comprises circuitry to translate a communication written to a register by the processor and transmit the translated communication to an associated interface of the multiple interfaces or devices.

18. The process of claim 16, wherein:
the processor accesses the multiple interfaces or devices by accessing memory-mapped input output (MMIO) addresses.

19. The process of claim 16, wherein:
the baseboard management controller accesses the processor as a Peripheral Component Interconnect Express (PCIe) endpoint, Universal Serial Bus (USB) endpoint, or Improved Inter-Integrated Circuit (I3C) endpoint.

20. The process of claim 16, wherein:
the processor comprises a processor socket, socket-level partition, or sub-socket level partition.
